(19) United States
(12) Patent Application Publication
(10) Pub. No.: US 2026/0097498 A1
(43) Pub. Date: Apr. 9, 2026

(54) SYSTEM AND METHOD FOR POINT CLOUD REGISTRATION USING AN EXHAUSTIVE OR SEMI-EXHAUSTIVE SEARCH METHOD

(71) Applicant: Toyota Research Institute, Inc., Los Altos, CA (US)

(72) Inventors: Richard Cheng, Cupertino, CA (US); Chavdar Chavdarov Papazov, Sunnyvale, CA (US); Daniel M. Helmick, Cupertino, CA (US); Mark Edward Tjersland, Mountain View, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/976,747

(22) Filed: Dec. 11, 2024

Related U.S. Application Data
(60) Provisional application No. 63/704,140, filed on Oct. 7, 2024.

(51) Int. Cl. B25J 9/16; B25J 9/02

(52) U.S. Cl. CPC B25J 9/1664; B25J 9/02

(57) ABSTRACT

Systems and methods for performing point cloud registration are described herein. In one example, a system includes a processor and a memory having instructions that, when executed by the processor, cause the processor to iterate through translation candidates and rotation candidates to determine a rigid transformation that best aligns a first point cloud and a second point cloud. Once determined, the processor may utilize the rigid translation to control the movement of a robotic device, such as a robotic arm, vehicle, etc.

### CROSS-REFERENCE TO RELATED APPLICATION

This application claims priority to U.S. Provisional Patent Application No. 63/704,140, filed on Oct. 7, 2024, the contents of which are hereby incorporated by reference in its entirety.

### TECHNICAL FIELD

The subject matter described herein relates, in general, to systems and methods for performing point cloud registration.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Point cloud registration involves the alignment of two or more point clouds into a common coordinate system. This process is used in applications such as 3D reconstruction, object recognition, robotic control/movement, and autonomous navigation. The goal is to determine the optimal transformation (translation and rotation) that aligns the point clouds as accurately as possible. This alignment allows for the integration of data from different viewpoints or sensors, creating a comprehensive and unified 3D model.

Current methodologies for point cloud registration can be broadly categorized into two main types: coarse registration and fine registration. Coarse registration provides an initial alignment, often using feature-based methods to match key points between point clouds. Techniques such as the Fast Point Feature Histograms (FPFH) and the Sample Consensus Initial Alignment (SAC-IA) are commonly used for this purpose. Fine registration, on the other hand, refines this initial alignment to achieve higher accuracy. The Iterative Closest Point (ICP) algorithm and its variants, such as Generalized ICP and Normal Distributions Transform (NDT), are widely used for fine registration. While ICP and its many variants are computationally efficient, they are sensitive to bad initializations and sensor noise.

More recently, deep learning has been utilized to perform point cloud registration. Moreover, supervised and unsupervised learning approaches have been developed to improve the robustness and efficiency of registration. These methods leverage neural networks to learn feature representations and transformations directly from data. However, deep learning approaches are very brittle when it comes to out-of-domain scenarios not covered by their training data.

### SUMMARY

This section generally summarizes the disclosure and is not a comprehensive explanation of its full scope or all its features.

In one embodiment, a system includes a processor and a memory having instructions that, when executed by the processor, cause the processor to iterate through translation candidates and rotation candidates to determine a rigid transformation that best aligns a first point cloud and a second-point cloud. As will be explained in the detailed description section, this iterative search may be exhaustive or semi-exhaustive. Once determined, the processor may utilize the rigid translation to control the movement of a robotic device, such as a robotic arm, vehicle, etc.

In another embodiment, a method includes the steps of iterating through translation candidates and rotation candidates to determine a rigid transformation that best aligns a first point cloud and a second point cloud. Like before, the rigid transformation may be utilized to control the movement of a robotic device.

In yet another embodiment, a non-transitory computer-readable medium may include instructions that, when executed by a processor, cause the processor to iterate through translation candidates and rotation candidates to determine a rigid transformation that best aligns a first point cloud and a second point cloud. Again, the rigid transformation may be utilized to control the movement of a robotic device.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of performing point cloud registration of two point clouds.

FIG. 2 illustrates one example of a system incorporating a point cloud registration system that utilizes an exhaustive or semi-exhaustive search to determine a rigid transform that best aligns two point clouds.

FIG. 3 is a more detailed view of the point cloud registration system if FIG. 2.

FIG. 4 illustrates a method that utilizes an exhaustive or semi-exhaustive search to determine a rigid transform that best aligns two point clouds.

### DETAILED DESCRIPTION

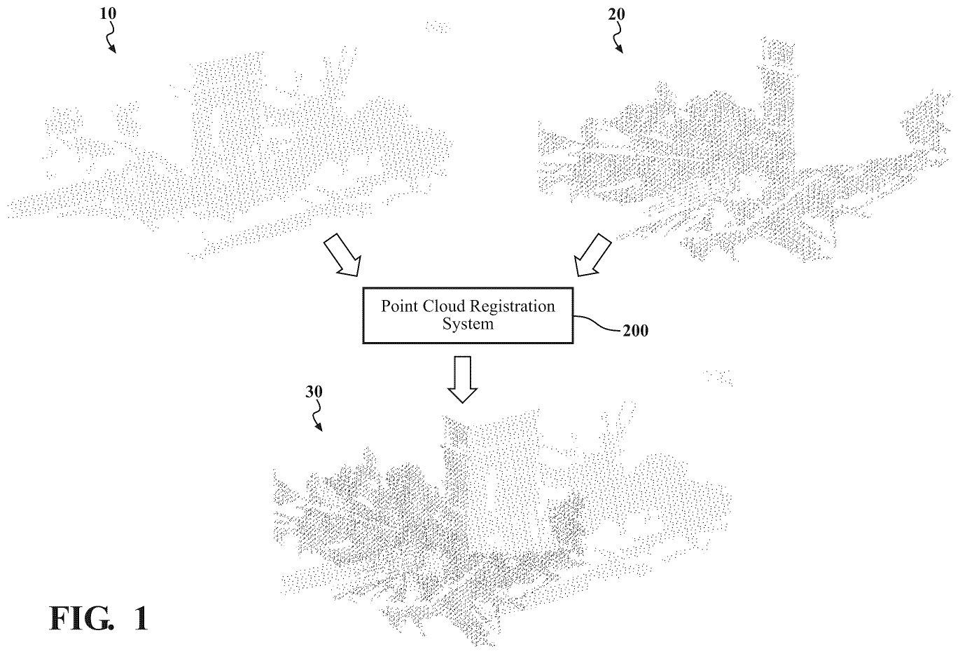

As mentioned in the background section, point cloud registration is the process in which two or more point clouds are aligned in a common coordinate system. For example, referring to FIG. 1, illustrated is a first point cloud 10 and a second point cloud 20. The first point cloud 10 may partially overlap the second point cloud 20, or vice versa. In some cases, the first point cloud 10 may be a subset of a full scene, while the second point cloud 20 may be a point cloud of the entire scene, or vice versa.

Regardless of the different types of point clouds, the point cloud registration system 200 performs point cloud registration to essentially align the first point cloud 10 and the second point cloud 20, as shown as point cloud 30. As will be explained in greater detail later, the point cloud registration system 200 performs point cloud registration by utilizing an algorithmically simple but computationally complex exhaustive and/or semi-exhaustive search approach that is generally suited for parallelization for systems that utilize graphics processing units (GPUs).

Moreover, the point cloud registration system 200 may iterate through numerous rotation/translation candidates to find the error-minimizing solution that acts as the rigid transformation. As mentioned in the background section, while ICP and its many variants are computationally efficient, they are sensitive to bad initializations and sensor noise. Likewise, machine learning approaches are very brittle when it comes to out-of-domain scenarios not covered by their training data. As such, the point cloud registration system 200 achieves greater robustness of solutions than the traditional prior art approaches.

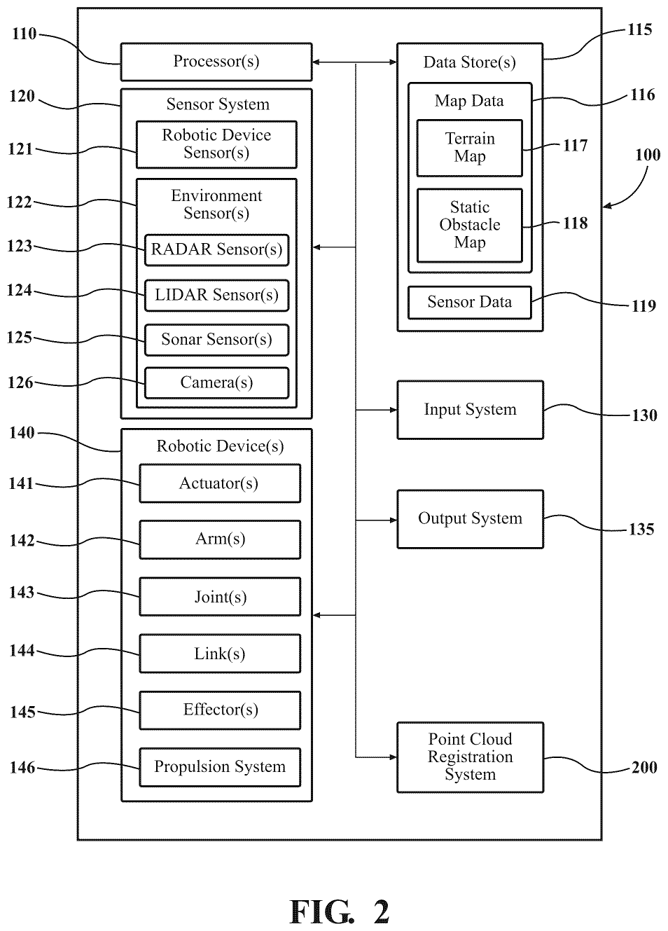

Referring to FIG. 2, an example of a robot 100 is illustrated. As used herein, a “robotic” is a device that can perform specific tasks with reduced or no human intervention. As such, the robot 100 can take any one of a number of different forms, such as a robotic manipulator, semi-autonomous/autonomous vehicle, or any other device that can perform tasks with reduced or no human intervention. In one or more implementations, the robot 100 may include sensors to perceive aspects of the surrounding environment and thus benefit from the functionality discussed herein associated with improving point cloud registration.

The robot 100 also includes various elements. It will be understood that in various embodiments, it may not be necessary for the robot 100 to have all of the elements shown in FIG. 2. The robot 100 can have any combination of the various elements shown in FIG. 2. Further, the robot 100 can have additional elements to those shown in FIG. 2. In some arrangements, the robot 100 may be implemented without one or more of the elements shown in FIG. 2. While the various elements are shown as being located within the robot 100 in FIG. 2, it will be understood that one or more of these elements can be located external to the robot 100. Further, the elements shown may be physically separated by large distances. For example, as discussed, one or more components of the disclosed system can be implemented within the robot 100, while further components of the system are implemented within a cloud-computing environment or another system that is remote from the robot 100.

Some of the possible elements of the robot 100 are shown in FIG. 2 and will be described along with subsequent figures. However, a description of many of the elements in FIG. 2 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. However, those skilled in the art will understand that the embodiments described herein may be practiced using various combinations of these elements.

In either case, the robot 100 includes a point cloud registration system 200 that is implemented to perform methods and other functions as disclosed herein relating to improving point cloud registration. As will be discussed in greater detail, the point cloud registration system 200, in various embodiments, may be implemented partially within the robot 100 and/or as a cloud-based service.

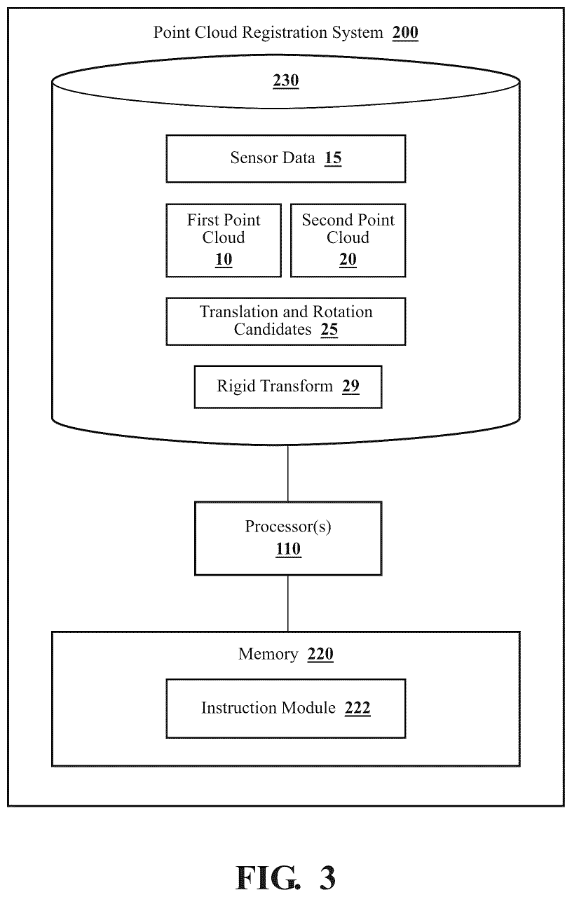

With reference to FIG. 3, one embodiment of the point cloud registration system 200 of FIG. 2 is further illustrated. The 6D pose and size estimator system 170 includes a processor(s) 110 from the robot 100 of FIG. 2. Accordingly, the processor(s) 110 may be a part of the point cloud registration system 200. The point cloud registration system 200 may include a separate processor from the processor(s) 110 of the robot 100 or the point cloud registration system 200 may access the processor(s) 110 through a data bus or another communication path.

In one embodiment, the point cloud registration system 200 includes a memory 220 that may store an instruction module 222. The memory 220 may be a random-access memory (RAM), read-only memory (ROM), a hard disk drive, a flash memory, or other suitable memory for storing the instruction module 222. The instruction module 222 is, for example, computer-readable instructions that, when executed by the processor(s) 110, cause the processor(s) 110 to perform the various functions disclosed herein.

The point cloud registration system 200 may be implemented between the robot 100 and a cloud-computing environment. The point cloud registration system 200 may be embodied at least in part within a cloud-computing environment. According to some embodiments, the point cloud registration system 200 is embodied entirely within the cloud-computing environment.

Furthermore, in one embodiment, the point cloud registration system 200 includes a data store 230. The data store 230 is, in one embodiment, an electronic data structure such as a database that is stored in the memory 220 or another memory and that is configured with routines that can be executed by the processor(s) 110 for analyzing stored data, providing stored data, organizing stored data, and so on. Thus, in one embodiment, the data store 230 stores data used by the instruction module 222 in executing various functions.

In one embodiment, the data store 230 includes sensor data 15 that may be collected from the sensor system 120 of the robot 100. In addition, the data store 230 may store one or more point clouds, such as the first point cloud 10 and the second point cloud 20. As explained before, the first point cloud 10 may overlap, at least partially, the second point cloud 20, or vice versa. Also, the data store 230 may include the translation and rotation candidates 25. In some cases, the number of the translation and rotation candidates 25 may be numerous and may be in the millions or even billions. As will be explained later, the point cloud registration system 200 can iterate through the translation and rotation candidates 25 to determine candidates that best align the first point cloud 10 with the second point cloud 20.

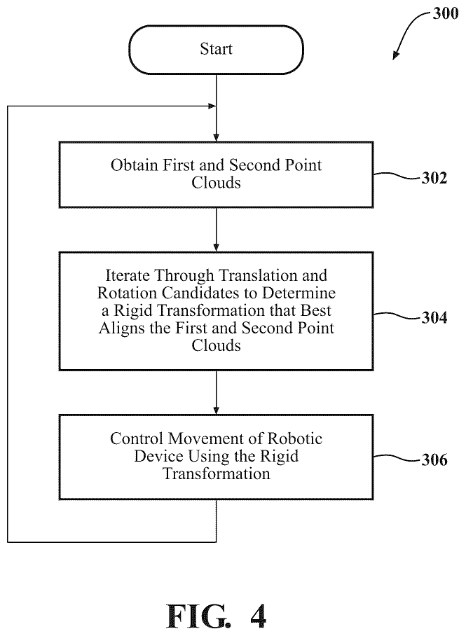

Accordingly, the instruction module 222 generally includes instructions that function to control the processor(s) 110 to determine a rigid transform 29 that best aligns the first point cloud 10 with the second point cloud 20. The methodology implemented executed by the processor(s) 110 in accordance with the instructions stored within the instruction module 222 is shown in a simplified form as method 300 in FIG. 4. The method 400 will be described from the viewpoint of the robot 100 of FIG. 2 and the point cloud registration system 200 of FIG. 3. However, it should be understood that this is just one example of implementing the method 300. While method 300 is discussed in combination with point cloud registration system 200, it should be appreciated that the method 300 is not limited to being implemented within point cloud registration system 200 but is instead one example of a system that may implement the method 300.

In step 302, the instructions of the instruction module 222, when executed by the processor(s) 110, cause the processor(s) 110 to obtain the first point cloud 10 and the second point cloud 20. This may be achieved by receiving data from the sensor system 120 of the robot 100. In some cases, the point clouds may be generated by the environment sensor(s) 122. In particular, the first point cloud 10 and the second point cloud 20 may be generated by the same or different light detection and ranging (LIDAR) sensor(s) 124. In other cases, the first point cloud 10 and/or the second point cloud 20 may be generated using information from other sensors. For example, images captured by the camera(s) 126 may be utilized to generate a pseudo-point cloud that may act as the first point cloud 10 and/or the second point cloud 20.

In step 304, the instructions of the instruction module 222, when executed by the processor(s) 110, cause the processor(s) 110 to iterate through the translation and rotation candidates 25 to determine a rigid transform that best aligns the first point cloud 10 and the second point cloud 20. This iteration may be performed by a pure exhaustive search, but can also be performed using a direct semi-exhaustive search, which may be more efficient. This description will describe both methodologies that may be utilized in step 304.

Before explaining the pure exhaustive and direct semi-exhaustive search, a problem setup will be provided in this paragraph. Consider the point cloud registration system 200 is given a source point cloud X (the first point cloud 10)={xᵢ∈ [symbol] ³|i=1, . . . , N} and a reference point cloud Y (the second point cloud 20)={yⱼ∈ [symbol] ²|j=1, . . . , N}. The goal of the point cloud registration system 200 is to compute the rigid transform 29, {R,t}∈SE(3), that optimally aligns the point clouds X (first point cloud 10) and Y (second point cloud 20). This may be expressed mathematically as,

$${arg min}_{R ∈ SO ( 3 ) , t ∈ {ℝ}^{3}} {\sum }_{{x}_{i} ∈ X} {min}_{{y}_{j} ∈ Y} {‖ {y}_{j} - {Rx}_{i} - t ‖}_{p} \qquad ( 1 )$$

where p is any desired norm. While most prior art considers p=2 for computational convenience and speed, p∈(0, 1] or truncated norms may be utilized to obtain more robust results. In this example, the point cloud registration system is focused on a partial-to-full point cloud registration setting. As such, Y (the second point cloud 20) represents the full object and X (the first point cloud 10) may represent a portion of that object, as observed from the environment sensor(s) 122 of the robot 100.

Beginning with the exhaustive search methodology, a pure exhaustive search approach to solving the optimization would be to discretize over all six rotational/translational degrees of freedom (DOFs) to find the rigid transform 29, represented as {R,t}∈SE(3), that optimally aligns the first point cloud 10 and the second point cloud 20, by creating a 6D grid of rotations/translations. Moreover, given point clouds X (the first point cloud 10) and Y (the second point cloud 20), the instructions of the instruction module 222, when executed by the processor(s) 110, cause the processor(s) 110 to compute the alignment error for each discrete rotation/translation, where the nearest neighbor is computed by iterating over each point-point pair between point clouds X (the first point cloud 10) and Y (the second point cloud 20).

$$ERROR ( R , t ) = {\sum }_{{x}_{i} ∈ X} {min}_{{y}_{j} ∈ Y} {‖ {y}_{j} - {Rx}_{i} - t ‖}_{p} \qquad ( 2 )$$

The {R,t}∈SE(3) that yields the minimum error is then the optimal solution. The overall algorithm is fairly simple and is outlined in Algorithm 1.

This exhaustive search method outlined in Algorithm 1 is optimal by definition (up to the discretization resolution) as it iterates through every possible combination in the discrete grid and allows the point cloud registration system 200 to optimize over different metrics. For example, these other metrics can include an L₁ norm, an L₂ norm, a Huber norm, and generalized distance metrics. It is noted that the algorithm is highly amenable to GPU parallelization since it has to discretize over 6 rotational/translational dimensions and iterate over every point pair in point clouds X and Y. The computation required for this approach scales O(K⁶MN), where K represents the discretization for each dimension, and N, M represent the number of points in point clouds X, Y, respectively. Also, it should be noted that instead of sampling the translation and rotation candidates 25, the point cloud registration system 200 could sample triplets of correspondence pairs and compute the optimal closed form poses for such triplets.

As mentioned before, instead of utilizing an exhaustive search in step 304, a direct semi-exhaustive search could be utilized to boost efficiency by iterating only over rotations, R∈SO(3), and efficiently computing the inlier-maximizing translation for each rotation R instead of iterating through every potential rotation/translation combination. The inlier-maximizing translation in terms of may be defined as L₀-“norm”, L₀^{m1},

$${L}_{0}^{m 1} ( t \vert {x}_{i} , {y}_{j} ) = min ( {‖ {y}_{j} - {Rx}_{i} - t ‖}_{0} , 1 ) \qquad ( 3 )$$

$$INLIERS ( t ) = {\sum }_{{x}_{i} ∈ X} {min}_{{y}_{j} ∈ Y} {L}_{0}^{m 1} ( t \vert {x}_{i} , {y}_{j} ) .$$

### Here,

$${L}_{0}^{m 1}$$

may be the L₀“norm” saturated at 1. For a given rotation, the inlier-maximizing translation may be considered as:

$${t}^{*} = {arg min}_{t ∈ {ℝ}^{3}} {\sum }_{{x}_{i} ∈ X} {min}_{{y}_{j} ∈ Y} {L}_{0}^{m 1} ( t \vert {x}_{i} , {y}_{j} ) . \qquad ( 4 )$$

As described in Lemma 2 below, the

$${L}_{0}^{m 1}$$

optimal (inlier maximizing) translation t* for the problem (4) can be computed, under mild assumptions, by taking the mode of translations between every rotated point-point pair.

Lemma 2: Suppose that no points within X are the same and that no points within Y are the same. Then the optimal solution to the problem (4) is

$${t}^{*} = MODE ( \{ {y}_{j} - {Rx}_{i} \vert {x}_{i} ∈ X , {y}_{j} ∈ Y \} ) . \qquad ( 5 )$$

Obviously, the

$${L}_{0}^{m 1}$$

norm over continuous points is fairly nonsensical. However, since the point cloud registration system 200 discretizes the points, the

$${L}_{0}^{m 1}$$

norm should be considered over a discrete grid. Therefore, the point cloud registration system 200 can consider the

$${L}_{0}^{m 1 \_}$$

minimizing solution equivalently as the inlier-maximizing solution, given some discretization distance d.

Given Lemma 2, the instructions of the instruction module 222 can cause the processor(s) 110 to iterate over every orientation Rθ,φ,ξ and use (5) to compute the corresponding inlier maximizing translation

$${t}_{θ , ϕ , ξ}^{*}$$

(up to the discretization δₜ). This may be done by counting/storing discrete translation candidates from each point-pair in an array and taking the argument of the maximum (argmax) of this array. More simply, the instructions of the instruction module 222 can cause the processor(s) 110 to only have to iterate over a 3D grid rather than a 6D grid of orientations (rotations) and translations. Once the candidate set of rigid transformations

$$( {R}_{θ , ϕ , ξ} , {t}_{θ , ϕ , ξ}^{*} )$$

are determined, the instructions of the instruction module 122 can cause the processor(s) 110 to sort them by the

$${L}_{0}^{m 1}$$

error. After that, the instructions of the instruction module 122 can cause the processor(s) to compute the optimal rigid transform 29 using the desired Lₚ-norm by brute-force computing the error associated with the best q % of candidate rigid transforms (as defined by

$${L}_{0}^{m 1}$$

error). This process may be completely parallelizable.

However, suppose that no points within X are within the discretization distance δₜ of each other, and that no points within Y are within the discretization distance δ^{t} of each other. If one chooses

$${L}_{0}^{m 1}$$

error as the desired Lₚ norm, then Algorithm 2 yields the inlier-maximizing solution to the problem (1) up to the chosen discretization.

Regardless of the type of algorithm (exhaustive search or direct semi-exhaustive search), as shown in step 306, once the appropriate rigid transform 29 has been determined that best aligns the first point cloud to the second point cloud 20, the instructions of the instruction module 222 can cause the processor(s) 110 operate one or more robotic device(s) 140 using the rigid transform 29 and other information, such as robotic commands. As will be explained later, the robotic device(s) 140 can take any one of a number of different forms.

FIG. 2 will now be discussed as an example environment within which the system and methods disclosed herein may operate. As mentioned before, the robot 100 can be any type of robotic device, such as a robotic manipulator, autonomous vehicle, and the like.

In the case that the robot 100 is a robotic manipulator, the robot 100 may include one or more arm(s) 142, joint(s) 143, link(s) 144, effector(s) 145, wrist(s) 146, and the like. The robot 100 may be capable of movement and may also include a propulsion system 147. The arm(s) 142, joint(s) 143, link(s) 144, effector(s) 145, wrist(s) 146, and/or the propulsion system 147 may require the use of one or more actuator(s) 141 that cause the movement of any of these items allowing the robot 100 to perform a specified task.

The actuator(s) 141 can be any element or combination of elements operable to modify, adjust, and/or alter one or more of the robotic device(s) 140 or components thereof to be responsive to receiving signals or other inputs from the processor(s) 110. Any suitable actuator can be used. For instance, actuator(s) 141 can include motors, pneumatic actuators, hydraulic pistons, relays, solenoids, and/or piezoelectric actuators, to name a few possibilities.

In the case that the robot 100 is a vehicle, the robotic device may include numerous vehicle systems, such as braking systems, steering systems, throttle systems, transmission systems, signaling systems, and/or navigation systems, and the like. If the robot 100 is a vehicle, the robot 100 may be an autonomous vehicle. As used herein, “autonomous vehicle” refers to a vehicle that operates in an autonomous mode. “Autonomous mode” refers to navigating and/or maneuvering the vehicle along a travel route using one or more computing systems to control the vehicle with minimal or no input from a human driver. In one or more embodiments, the vehicle is highly automated or completely automated. In one embodiment, the vehicle is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the robot 100 along a travel route.

The robot 100 can include one or more processor(s) 110. In one or more arrangements, the processor(s) 110 can be the main processor of the robot 100. For instance, the processor(s) 110 can be an electronic control unit (ECU). The robot 100 can include one or more data store(s) 115 for storing one or more types of data. The data store(s) 115 can include volatile and/or non-volatile memory. Examples of data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data store(s) 115 can include map data 116. The map data 116 can include maps of one or more geographic areas. In some instances, the map data 116 can include information regarding the environment in which the robot 100 operates. For example, if the robot 100 is a robotic manipulator utilized in a household, the map data 116 may include a map of the household in which the robot 100 operates. If the robot 100 is a vehicle, the map data 116 may include data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, including factory/building floors, paved roads, unpaved roads, land, and other things that define a ground surface.

In one or more arrangements, the map data 116 can include one or more static obstacle map(s) 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include furniture, industrial machines, household appliances, trees, buildings, curbs, fences, railings, medians, utility poles, statues, monuments, signs, benches, furniture, mailboxes, large rocks, and hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data store(s) 115 can include sensor data 119. In this context, “sensor data” means any information about the sensors that the robot 100 is equipped with, including the capabilities and other information about such sensors. As will be explained below, the robot 100 can include the sensor system 120. The sensor data 119 can relate to one or more sensors of the sensor system 120. As an example, in one or more arrangements, the sensor data 119 can include information on one or more LIDAR sensor(s) 124 of the sensor system 120.

In some instances, at least a portion of the map data 116 and/or the sensor data 119 can be located in one or more data store(s) 115 located onboard the robot 100. Alternatively, or in addition, at least a portion of the map data 116 and/or the sensor data 119 can be located in one or more data store(s) 115 that are located remotely from the robot 100.

As noted above, the robot 100 can include the sensor system 120. The sensor system 120 can include one or more sensors. “Sensor” means any device, component, and/or system that can detect and/or sense something. The one or more sensors can be configured to detect and/or sense in real-time. As used herein, the term “real-time” means a level of processing responsiveness that a user or system senses as sufficiently immediate for a particular process or determination to be made or that enables the processor to keep up with some external process.

In arrangements in which the sensor system 120 includes a plurality of sensors, the sensors can work independently from each other. Alternatively, two or more of the sensors can work in combination with each other. In such cases, the two or more sensors can form a sensor network. The sensor system 120 and/or the one or more sensors can be operatively connected to the processor(s) 110, the data store(s) 115, and/or another element of the robot 100 (including any of the elements shown in FIG. 2). The sensor system 120 can acquire data of at least a portion of the external environment of the robot 100.

The sensor system 120 can include any suitable type of sensor. Various examples of different types of sensors will be described herein. However, it will be understood that the embodiments are not limited to the particular sensors described. The sensor system 120 can include one or more robotic device sensor(s) 121. The robotic device sensor(s) 121 can detect, determine, and/or sense information about the robot 100 itself. In one or more arrangements, the robotic device sensor(s) 121 can be configured to detect and/or sense position and orientation changes of the robot 100, such as, for example, based on inertial acceleration. In one or more arrangements, the robotic device sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The robotic device sensor(s) 121 can be configured to detect and/or sense one or more characteristics of the robot 100. In one or more arrangements, the robotic device sensor(s) 121 can include a speedometer to determine the current speed of the robot 100.

Alternatively, or in addition, the sensor system 120 can include one or more environment sensor(s) 122 configured to acquire and/or sense environment data. “Environment data” includes data or information about the external environment in which a robot 100 is located or one or more portions thereof. For example, the one or more environment sensor(s) 122 can be configured to detect, quantify, and/or sense obstacles in at least a portion of the external environment of the robot 100 and/or information/data about such obstacles. Such obstacles may be stationary objects and/or dynamic objects. The one or more environment sensor(s) 122 can be configured to detect, measure, quantify, and/or sense other things in the external environment of the robot 100.

Various examples of sensors of the sensor system 120 will be described herein. The example sensors may be part of the one or more environment sensor(s) 122 and/or the one or more robotic device sensor(s) 121. However, it will be understood that the embodiments are not limited to the particular sensors described.

As an example, in one or more arrangements, the sensor system 120 can include one or more radar sensor(s) 123, one or more LIDAR sensor(s) 124, one or more sonar sensor(s) 125, and/or one or more camera(s) 126. In one or more arrangements, the one or more camera(s) 126 can be high dynamic range (HDR) cameras, infrared (IR) cameras, and/or stereo cameras.

The robot 100 can include an input system 130. An “input system” includes any device, component, system, element, arrangement, or groups thereof that enable information/data to be entered into a machine. The input system 130 can receive an input from an operator of the robot 100. The robot 100 can include an output system 135. An “output system” includes any device, component, arrangement, or groups thereof that enable information/data to be presented to an operator of the robot 100.

The processor(s) 110 can be operatively connected to communicate with the robotic device(s) 140 and/or individual components thereof. For example, returning to FIG. 2, the processor(s) 110 can be in communication to send and/or receive information from the robotic device(s) 140 to control the movement, speed, maneuvering, heading, direction, etc. of the robot 100. The processor(s) 110 may control some or all of these robotic device(s) 140 and, thus, may be partially or fully autonomous.

The processor(s) 110 can be operatively connected to communicate with the robotic device(s) 140 and/or individual components thereof. For example, returning to FIG. 2, the processor(s) 110 can be in communication to send and/or receive information from the robotic device(s) 140 to control the movement, speed, maneuvering, heading, direction, etc. of the robot 100. The processor(s) 110 may control some or all of these robotic device(s) 140.

The robot 100 can include one or more modules, at least some of which are described herein. The modules can be implemented as computer-readable program code that, when executed by a processor(s) 110, implements one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store(s) 115 may contain such instructions.

In one or more arrangements, one or more of the modules described herein can include artificial or computational intelligence elements, e.g., neural networks, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements can also be embedded in an application product that comprises all the features enabling the implementation of the methods described herein and when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but is not limited to, an electronic, magnetic, optical, electromagnetic, infrared, or semiconductor system, apparatus, device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, RAM, ROM, flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. For example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, as indicating the scope hereof.

What is claimed is:

1. A system comprising a memory having instructions that, when executed on a processor, causes the processor to:
iterate through translation candidates and rotation candidates to determine a rigid transformation that best aligns a first point cloud and a second point cloud; and
control a movement of a robotic device using the rigid transformation.

2. The system of claim 1, wherein the first point cloud at least partially overlaps the second point cloud.

3. The system of claim 1, wherein the memory further includes instructions that, when executed by the processor, cause the processor to:
determine an alignment error for the translation candidates and the rotation candidates that indicates a discrepancy between positions of corresponding points in the first point cloud and the second point cloud; and
determine the rigid transformation from the translation candidates and the rotation candidates based on the alignment error.

4. The system of claim 3, wherein the alignment error is determined by the processor using at least one of an L₁ norm, an L₂ norm, a Huber norm, and generalized distance metrics.

5. The system of claim 1, wherein the memory further includes instructions that, when executed by the processor, cause the processor to determine an inlier-maximizing translation associated with each of the rotation candidates to generate the translation candidates.

6. The system of claim 1, wherein the robotic device is an arm of a robot.

7. The system of claim 1, wherein the robotic device is a vehicle.

8. A method comprising:
iterating through translation candidates and rotation candidates to determine a rigid transformation that best aligns a first point cloud and a second point cloud; and
controlling a movement of a robotic device using the rigid transformation.

9. The method of claim 8, wherein the first point cloud at least partially overlaps the second point cloud.

10. The method of claim 8, further comprising:
determining an alignment error for the translation candidates and the rotation candidates that indicates a discrepancy between positions of corresponding points in the first point cloud and the second point cloud; and
determining the rigid transformation from the translation candidates and the rotation candidates based on the alignment error.

11. The method of claim 10, wherein the alignment error is determined using at least one of an L₁ norm, an L₂ norm, a Huber norm, and generalized distance metrics.

12. The method of claim 8, further comprising determining an inlier-maximizing translation associated with each of the rotation candidates to generate the translation candidates.

13. The method of claim 8, wherein the robotic device is an arm of a robot.

14. The method of claim 8, wherein the robotic device is a vehicle.

15. A non-transitory computer-readable medium having instructions that, when executed by a processor, cause the processor to:
iterate through translation candidates and rotation candidates to determine a rigid transformation that best aligns a first point cloud and a second point cloud; and
control a movement of a robotic device using the rigid transformation.

16. The non-transitory computer-readable medium of claim 15, wherein the first point cloud at least partially overlaps the second point cloud.

17. The non-transitory computer-readable medium of claim 15, further comprising instructions that, when executed by the processor, cause the processor to:
determine an alignment error for the translation candidates and the rotation candidates that indicates a discrepancy between positions of corresponding points in the first point cloud and the second point cloud; and
determine the rigid transformation from the translation candidates and the rotation candidates based on the alignment error.

18. The non-transitory computer-readable medium of claim 17, wherein the alignment error is determined by the processor using at least one of an L₁ norm, an L₂ norm, a Huber norm, and generalized distance metrics.

19. The non-transitory computer-readable medium of claim 15, further comprising instructions that, when executed by the processor, cause the processor to determine an inlier-maximizing translation associated with each of the rotation candidates to generate the translation candidates.

20. The non-transitory computer-readable medium of claim 15, wherein the robotic device is at least one of an arm of a robot and a vehicle.
